(19) United States
(12) Patent Application Publication
(10) Pub. No.: US 2008/0259226 A1
(43) Pub. Date: Oct. 23, 2008

(54) Mechanical Shutter with Polymerised Liquid Crystal Layer

(75) Inventors: Dirk Jan Broer, Eindhoven (NL); Christiane Maria Rosette De Witz, Eindhoven (NL); Grietje Neeltje Mol, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,579

(22) PCT Filed: Jan. 27, 2005
(86) PCT No.: PCT/IB05/50352

§ 371 Date: Jul. 31, 2006

(30) Foreign Application Priority Data
Feb. 4, 2004 (EP) 04100398.9

(51) Int. Cl. G02F 1/133

(52) U.S. Cl. 349/1

(57) ABSTRACT

The present invention relates to a mechanical shutter (601) that comprises a shutter element having a layer of polymerized liquid crystal. The polymerized liquid crystal is anisotropically oriented. At one major surface the orientation is an isotropic. In moving towards the opposite major surface the orientation varies, the variation being such that the thermal expansion coefficient varies in moving from the major surface to the opposite surface. When exposed to non-mechanical means such as heat, the shutter element moves. When for example a splayed or a twisted nematic orientation is used, the element bends and straightens in response to the non-mechanical means. Electrodes (604, 605, 606) can optionally be formed on the element and on a supporting substrate, rendering the element controllable by an electric field applied between the electrodes due to resulting electrostatic forces. The invention furthermore provides a method of manufacturing such mechanical shutters using in-situ polymerization.

The present invention relates to a mechanical shutter, a display element comprising such a shutter and a method of manufacturing such a shutter.

Micro-mechanical thermo structures are previously known, for example from U.S. Pat. No. 4,235,522. The technique described therein is based on roll-up devices manufactured according to the following procedure. A polyester film with a thickness of the order of 1 to 5 μm is coated with a thin aluminum coating. Such coated films are commercially available for use as capacitor films. The films are stretched and adhered locally in a striped pattern to a substrate which in turn is provided with a transparent ITO counter electrode. Subsequently, by laser cutting, the patterned rolling blinds are cut into the desired shapes. Due to the mechanical stress in the film, the free standing parts of the film (the flaps) brake loose from the substrate, possibly aided by added mechanical stress and/or a heating step, and rolls-up during cutting. Each element behaves as a shutter and is controllable by applying an electrical field over the electrode structure (the aluminum electrodes on the flaps and the ITO electrodes on the substrate). The electric field induces electrostatic forces in the respective flap which therefore unwinds from a rolled state into a straight state, thus blocking otherwise transmitted light.

Although this provides an elegant way to produce micro-mechanical shutters, the approach suffers from a number of disadvantages:

The laser cutting procedure remains limited to relatively large structures, typically 100 μm or more with open lines of 20 μm or more due to the limited resolution in the laser cutting process. This makes further miniaturization difficult, if not impossible.

The lamination process of the ultra-thin polyester film coated with the metal mirror is difficult. The film is difficult to handle because of its very small thickness and it is particularly difficult to spread it equally over large distances without disturbances. This also limits freedom in choice over film thickness optimized for the specific function that is desired, the thinner the film the bigger the handling difficulties.

There is no control in the direction that the blinds open and close. They all move into the same direction and no optimization towards a motion in a different direction is possible without cutting pieces of plastic film and mounting them locally with their respective orientation axes in different directions.

Hence there is a need for an improved mechanical shutter for modulating light beams, which overcomes the above stated problems and which thus provides a mechanical shutter that is easy to manufacture in many different designs.

To this end the present invention describes mechanical shutters that respond to temperature differences and/or electrostatic forces.

Thus, according to one aspect of the invention, a mechanical shutter having a light path controllably by a shutter element, wherein

said shutter element comprises a layer of oriented polymerized liquid crystal, the polymerized liquid crystal being oriented anisotropically near at least one major surface of the layer, and exhibiting, when moving from the at least one major surface towards the major surface opposite the at least one major surface, a variation in orientation and/or concentration;

the variation being such that the thermal expansion coefficient along a lateral extension of the shutter element is a function of a depth in said shutter element perpendicular to said lateral extension;

such that, at a first temperature, said shutter element is essentially flat and thus closes said light path, and, at a second temperature, said shutter element is bent and thus opens said light path.

Such a light shutter provides excellent shutter behavior as well as ease of manufacturing. The shutter element can be formed by polymerizing a polymerizable liquid crystal (e.g. a liquid crystal monomer) in an oriented state.

The mechanical shutter can have any size. For example, the layer can have a surface area of the order of about 1 cm2 to about 1 m2, but it can also be smaller, for example about 10 mm² to about 10.000 mm² or much smaller, for example about 10 μm² to about 10.000 μm², in the latter case the mechanical shutter also being referred to as a micro-mechanical shutter.

The average orientation of the liquid crystal monomers in the layer can be controlled prior to polymerization by means of external orientation layers during polymerization and/or by adding surfactants to the liquid crystal mixture in order to bring about the variation in orientation and/or concentration.

During polymerization, the orientation of the polymerizable liquid crystal is fixed into a polymer layer.

Basically it is enough for one particular lateral direction in the shutter element to exhibit a variation in orientation and/or concentration resulting in a thermal expansion coefficient that is a function of the depth. For example, the shutter element might be essentially rectangular and is then preferably suspended to a base substrate (or similar) along one of its outer edges. In such case it is enough for the lateral direction that is perpendicular to the suspended edge to have a depth-depending thermal expansion coefficient.

The layer of polymerized liquid crystal can in fact span a laminate of two or more layers, each having a separate orientation.

However, according to one advantageous embodiment, the shutter element comprises a layer of polymerized liquid crystal wherein the variation is continuous such that the thermal expansion coefficient along a lateral extension of the shutter element is a continuous function of a depth in said shutter element perpendicular to said lateral extension.

This is advantageous since it provides for ease of manufacturing. Any additional layer of liquid crystal mixture would require additional depositing steps.

A basis for the thermal response of the polymerized liquid crystal layer is that liquid crystal molecules have a different coefficient of thermal expansion along their long axes than perpendicular to those axes. Thereby the thermal response will depend on the average orientation of the molecules.

There are many ways to bring about a variation in orientation and/or concentration. In that respect reference is made to an application entitled “Flexible foil moveable by non-mechanical means” filed on the same day as the present application.

Specifically, according to one embodiment, the polymerized liquid crystal has a twisted nematic orientation. The twist is preferably 90 whereby the anisotropic orientation at the at least one major surface of the layer is perpendicular to the anisotropic orientation at the opposite face, and the intermediate molecules changes orientation gradually between the two perpendicular extreme orientations.

According to another embodiment, the polymerized liquid crystal has a splayed orientation. In such case the anisotropic orientation at the at least one major surface of the layer is parallel with the layer and the anisotropic orientation at the opposite face is perpendicular to the layer (i.e. the molecule orientation is homeotropic at that opposite face).

A layer containing such a polymerized liquid crystal orientation can be made by polymerizing a polymerizable liquid crystal that is applied as a thin film, e.g. by spin-coating, on a planar substrate. In such case the mixture is preferably dissolved in a solvent which is subsequently evaporated.

The substrate might be provided with a rubbed orientation layer. The molecules interfacing the orientation layer will then orient parallel with the rubbing direction of that orientation layer. The orientation layer can be formed out of polyimide. Commercial solution of polyimide can be bought, e.g. from AL3046 from JSR. It can be applied on the substrate as a thin film for instance by spin-coating and subsequent baking at 200° C. whereby solvent is removed. Thereafter the layer can be unidirectionally rubbed with a polyester fabric. However, rubbed polyvinylalcohol can be used in the orientation layer as an alternative for polyimide. An advantage of using polyvinylalcohol is that it can be dissolved in water after application and curing of the liquid crystal mixture. The polymerized layer can thus be removed from the substrate essentially without any force while maintaining the molecule orientation.

The polymerized liquid crystal is typically transparent in the visible part of the electro-magnetic spectrum, and will then in itself not provide for the light shutting property of the shutter element unless use is made of for instance polarizers exploiting the birefringent properties of the polymerized liquid crystal. It is however more convenient to dissolve a small quantity of a dye into the liquid crystal monomer mixture such that it absorbs visible light. Thus, according to one embodiment the liquid crystal mixture comprises a light absorbing dye. A convenient dye that covers a large part of the visible spectrum and that is well soluble in the monomer mixture is the following azo dye that is typically applied in a concentration of around 2 wt-%:

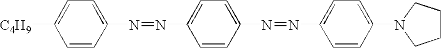

Another preferred method for blocking visible light is to coat the polymerized liquid crystal film with a separate, light-blocking layer. Thus, according to one embodiment the shutter element further comprises a light-blocking layer that is separate from the layer of polymerized liquid crystal. This layer can be an organic layer with absorbing (colored or black) or scattering (opaque) properties. But in a preferred embodiment it is a light reflecting metal layer such as aluminum. The light blocking layer is preferably applied in a thickness thin enough not to affect the mechanical behavior of the films (i.e. the bending properties). In case the shutter element is arranged such that one side faces a substrate, the separate light-blocking layer is preferably provided on the opposite side of the shutter element.

The shutter element can be controlled by heat variations. This is advantageous in applications where, for example, an automatic light shutter that is responsive to ambient temperature variations is desired. However, it might be a bit difficult to control the shutter element at will, for example in response to an electronic control unit, using heat signals. This is particularly the case for light shutters having a large number of shutter elements which should be controlled individually and which thus each requires a separate, controllable heat source.

To this end, according to one embodiment, the micro-mechanical shutter further comprises a base substrate to which the shutter element is suspended, a transparent base electrode provided on the base substrate across said light path, and a shutter electrode provided on said shutter element. Thereby the shutter element is controllable by means of an electrostatic force between said electrodes. This is actually an advantageous embodiment, since it allows the shutter to be controlled directly by means of electric forces appearing as a result of electric voltages applied to the respective electrodes. The transparent base electrode might for example be formed out of indium tin oxide.

Of course, in case the shutter element is controllable by means of electrostatic forces, the thermal expansion coefficient is actually of minor importance for the operation. Instead it is the flexural resistance (flexibility) of the shutter element that dictates the response to the electrostatic forces.

In case the shutter element is provided with a separate light blocking layer this is preferably incorporated with the shutter electrode. Thus, according to one embodiment the light blocking layer and the shutter electrode is formed out of a single, light blocking and electrically conductive material. Thereby the manufacturing is simplified. The material can, for example be aluminum, which in such case might be sputtered onto the shutter element.

As indicated above, the light shutter might comprise only one shutter element. However, most applications require a total aperture area that is larger than what is possible using a single shutter element. In addition, it is often desirable to be able to dynamically control different regions of the total aperture area, for example in a display application where each shutter element can be used to define and control a separate picture element (pixel). Therefore, according to one embodiment, the light shutter comprises an array of shutter elements that are individually controllable by means of separate electrodes.

Of course, arrays of shutter elements can be provided even if the shutter elements are not provided with electrodes.

The orientation might be the same throughout the entire shutter element, such that the coefficient of thermal expansion depends on the depth in the same manner in the whole shutter element. In such case the shutter element is typically controllable between a bent U-shape state and a straight, essentially flat state.

However, according to an embodiment, the layer of polymerized liquid crystal comprises a first and a second, spatially separate section wherein the variation is mutually different.

For example, a shutter element having a coefficient of thermal expansion that increases with the depth at one portion and that decreases with depth at another portion will typically bend in a S-shaped manner. Thus, by suitable choice of orientation in different sections of the shutter element, it is possible to provide elements bending in different way in response to temperature variations.

The micro-mechanical shutter can be used for many applications. According to one aspect of the invention, a display element comprising a micro-mechanical shutter is provided. The display element then preferably comprises a plurality of shutter elements, each defining a separate pixel. In display applications, it is particularly advantageous to provide an array of shutter elements that are arranged with individual electrodes as described above.

According to one embodiment, each shutter element is opaque and the display further comprises a color filter element provided in each light path. This configuration can be used for reflective as well as transmissive displays. In case the display is transmissive the color filter preferably is transmissive for a certain color and absorbs the remaining colors. When a shutter element is opened the corresponding pixel will then emit colored light originating from a backlight and when the shutter element is closed the corresponding pixel will be black. In case the display is reflective the color filter preferably is reflective for a certain color and absorbs the remaining colors.

According to another embodiment, the shutter element is reflective for light of a certain color and an essentially black, light-absorbing surface is provided in the light path. This configuration is particularly advantageous for reflective displays, wherein a pixel is colored in case the shutter element is closed (straight) and is black in case the shutter element is opened.

In addition to advantages in the light shutter as such, the light shutter is furthermore simple to manufacture using conventional manufacturing equipment and methods. The polymerizable liquid crystal layers can for example be formed by spin coating, doctor blading or slot die extrusion coaters, and the electrode layers can be formed for example by evaporation or sputter coating. Photo-initiated polymerization of the mixture enables lithographic exposure through masks giving a negative pattern of the mask as the illuminated parts will polymerize and become solid and insoluble, whereas the non-illuminated parts remain non-polymerized and soluble in normal organic solvents such as methylethylketone, xylene or tetrahydrofuran. However, methods other than photo-polymerization can be used for the in-situ polymerization.

Thus, according to another aspect of the present invention, a method of manufacturing a micro-mechanical shutter is provided the method comprising:

applying an orientation layer on a substrate;

applying a layer of a polymerizable liquid crystal on said orientation layer;

orienting and polymerizing said polymerizable liquid crystal thus defining at least one shutter element comprising a layer of oriented polymerized liquid crystal;

removing any excess polymerizable liquid crystal.

The manufacturing process involves the step of applying an orientation layer on said substrate and on said electrode layer. The orientation layer can for example be formed out of polyimide that is cured and subsequently rubbed with a polyester fabric. Thereafter a layer of polymerizable liquid crystal is applied on said orientation layer and the polymerizable liquid crystal is oriented and polymerized whereby at least one shutter element is defined. The polymerization can be carried out by photo-polymerization by selective exposure of ultraviolet light through a mask yielding a negative image of the mask in polymer. Finally, any excess polymerizable liquid crystal (e.g. below the opaque regions of the mask) is removed.

In case the layers are polymerized at elevated temperatures, preferably then above the glass transition temperature of the polymerized liquid crystal at hand, the polymerized layer will be more or less flat (i.e. straight and uncurved) at that elevated temperature. However, when the films are cooled to room temperature the film tends to build up a stress because the top of the film has a higher coefficient of thermal expansion than the bottom of the film when measured along a lateral direction. As long as the film is adhered to the substrate it will remain flat. But, as soon as the film is released from its substrate the force will bring the film into the rolled configuration.

In case the mechanical shutter comprises electrodes, the manufacturing process might further involve the step of providing a transparent electrode layer on the substrate prior to application of the liquid crystal mixture. The electrode layer can for example be formed out of indium tin oxide (ITO) which can be patterned by normal lithographic procedures including the application of a thin film of photo-resist material, exposing it to actinic radiation through a mask where the solubility of the ITO changes, developing the resist and dissolving the transparent electrode locally in an etching liquid such that an electrode pattern is obtained. The method of manufacturing then furthermore involves the step of applying a layer of electrically conducting material on the shutter element, thus defining a shutter electrode. The shutter electrode can for example be formed out of aluminum, and the step of applying the shutter electrode might then involve sputtering of aluminum on the shutter element.

According to one embodiment, the step of polymerizing involves photo-polymerizing through a mask, preferably preceded by a step of annealing said liquid crystal mixture at a temperature above 120° C. for at least 30 minutes.

In case a splayed orientation is desired, the liquid crystal mixture might contain a surfactant that tends to minimize free energy by orienting the long molecular axis perpendicular to the surface of any air interface (i.e. in a homeotropic orientation). Such a surfactant in combination with a rubbed orientation layer on the substrate will actually make the molecules orient themselves into a splayed configuration (parallel at the substrate and perpendicular at the opposite, air interfacing surface).

Thus, according to one embodiment, the polymerizable liquid crystal comprises a surfactant that promotes a homeotropic orientation of polymerizable liquid crystal monomers when interfacing air, and wherein the step of polymerizing is performed while exposing the polymerizable liquid crystal layer to air.

Alternatively, the perpendicular molecule orientation can be achieved by polymerizing the monomer against a second, temporary substrate that is modified with a surfactant. In such case the mixture does not need to contain any solvents but can instead be applied by filling a slit defined at one side by the (permanent) substrate coated with an orientation layer and at the other side by the temporary substrate that is modified with a surfactant that induces a perpendicular molecule orientation, e.g. octadecyl trimethoxy silane. The filling is preferably performed at elevated temperatures, e.g. 80° C., and under the action of naturally occurring capillary forces.

Thus, according to one embodiment, the method further comprises the step of providing a second, temporary substrate in contact with said polymerizable liquid crystal that induces a desired orientation in said polymerizable liquid crystal, and wherein said step of polymerizing said polymerizable liquid crystal is performed while said second, temporary substrate is in contact with said polymerizable liquid crystal.

However, molten liquid crystal mixture can be capillary filled between two substrates similar to above even in case a twisted nematic orientation is desired. In such case both substrates (the permanent substrate and the temporary substrate) should be provided with rubbed orientation layers having their rubbing directions perpendicular to each other. The orientation of the liquid-crystal molecules near the respective interfaces follows the direction of the respective rubbed orientation layer. In-between the average molecule orientation changes continuously from a first orientation to a second orientation that is perpendicular to the first orientation. In order to circumvent the formation of domains with different handedness of the twist rotation a minor amount, e.g. 0.1 wt_%, of a chiral dopant can be added to the system and will then control the direction of rotation. A suited chiral dopant that is commercially available under the name S811 (Merck, Darmstadt, Germany) and that will induce a left-handedness of the rotation is:

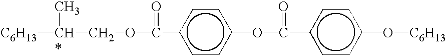

In the following, the invention will be described in further detail with reference to the accompanying, exemplifying drawings.

In the drawings:

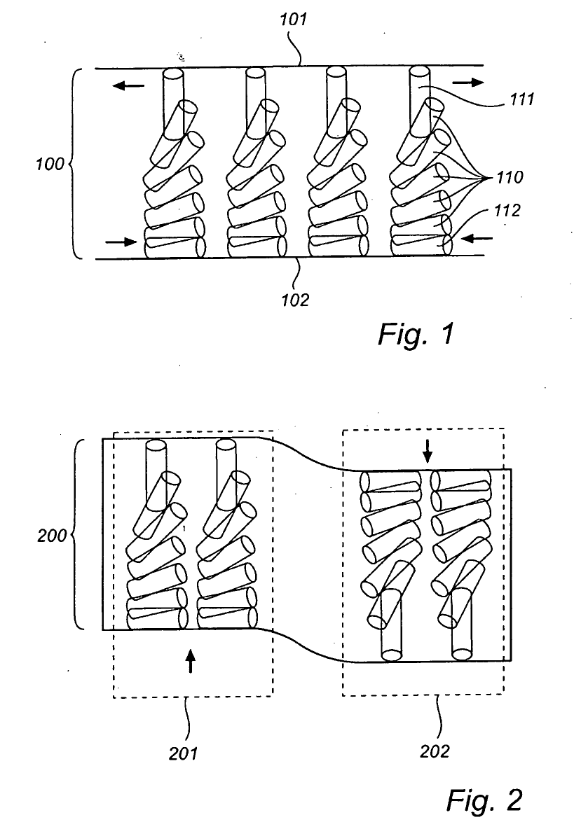

FIG. 1 illustrates, schematically, in a cross-sectional view, an orientation of a polymerized liquid crystal in a shutter element according to the present invention.

FIG. 2 illustrates, schematically, an orientation of a polymerized liquid crystal of another shutter element according to the present invention.

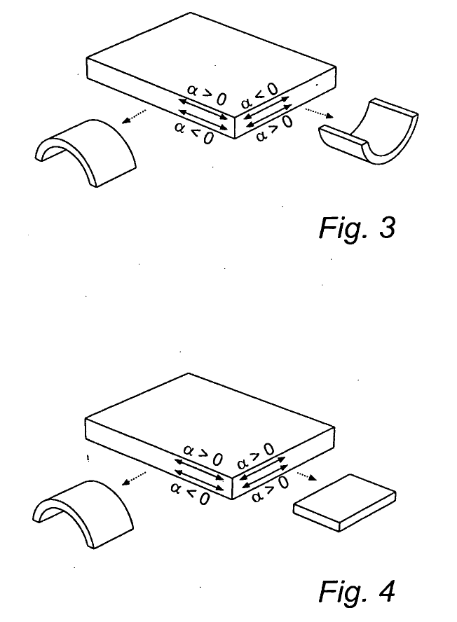

FIG. 3 illustrates, schematically, bending in an element having a twisted nematic orientation.

FIG. 4 illustrates, schematically, bending in an element having a splayed orientation.

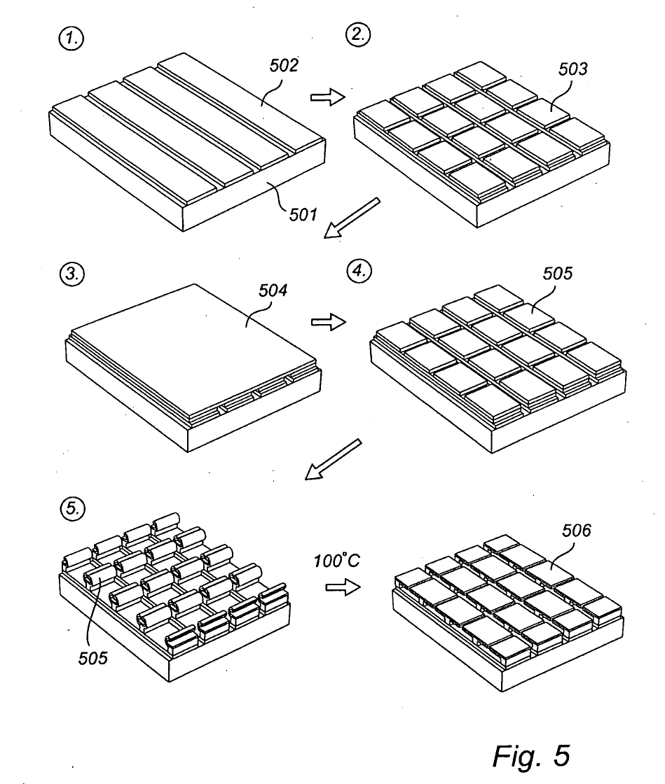

FIG. 5 illustrates manufacturing steps for manufacturing a mechanical shutter according to the present invention.

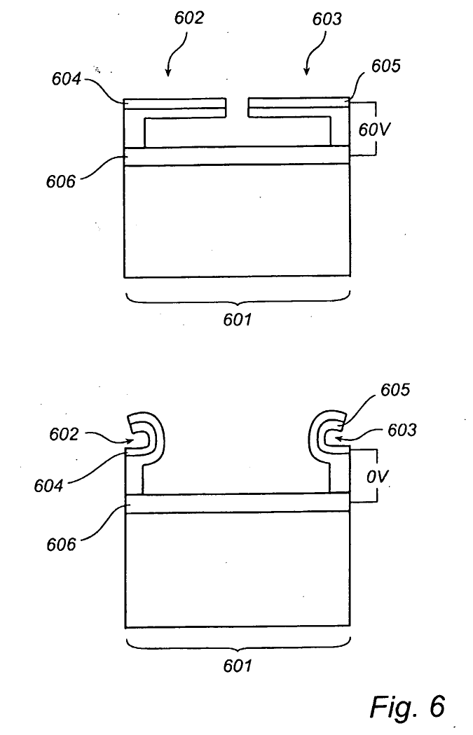

FIG. 6 illustrates the mechanical deformation (opening and closing) of the shutter under the action of an electric field.

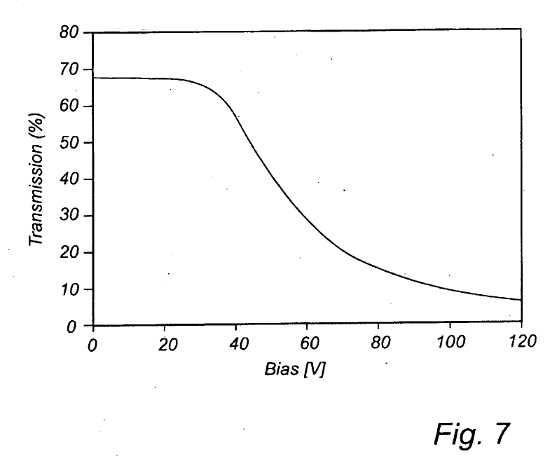

FIG. 7 is a curve showing the transmission response to different voltages applied across a mechanical shutter in accordance with the invention comprising a matrix array of shutter elements.

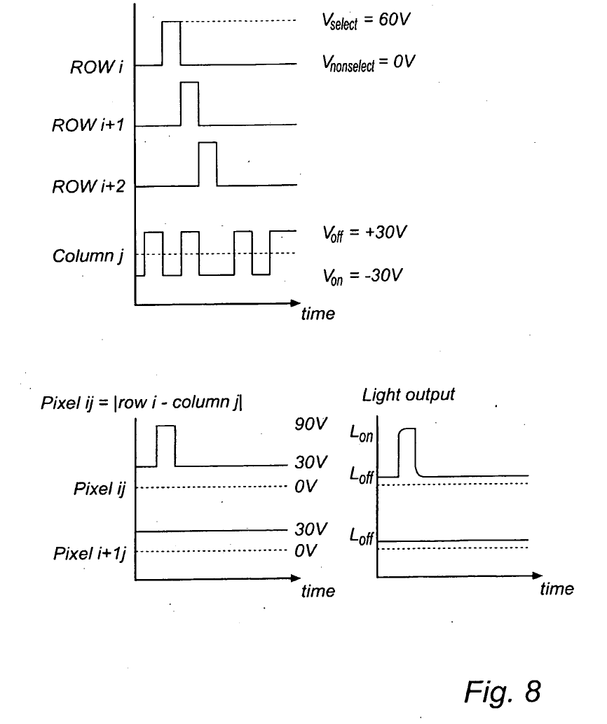

FIG. 8 illustrates a drive scheme for a mechanical shutter comprising a matrix array of shutter elements.

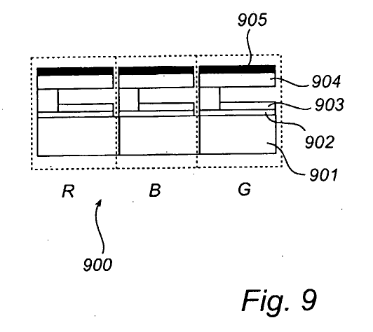

FIG. 9 illustrates a cross-section of a display element according to the present invention.

The mechanical response originates from the specific molecular orientation. The molecules can for example have a splayed orientation, as is schematically shown in FIG. 1. Thus, FIG. 1 illustrates a layer 100 of polymerized liquid crystal that has a top major surface 101 and a bottom major surface 102. The polymerized liquid crystal 112 which is close to the bottom surface is anisotropically oriented, the orientation being essentially parallel to the bottom surface 102. The liquid crystal molecules that are close to the top surface are also anisotropically oriented but essentially perpendicular to the top surface 101. The intermediate liquid crystal molecules 10 have a gradually tilting orientation going from almost parallel to almost perpendicular thus providing a continuous variation in orientation

The coefficient of thermal expansion in the polymerized liquid crystal depends on the orientation of the polymerized liquid crystal units contained therein. The coefficient of thermal expansion is typically higher perpendicular to the axes of such liquid crystal units than it is along the molecular axes. However, for discotic liquid crystals the opposite is typically true. But, assuming that the coefficient of thermal expansion is smaller along the axes, the layer illustrated in FIG. 1 would, when heated contract at the bottom surface 102 and expand at the top surface 101 (as indicated by the arrows), with the net result of a bend downwards when heated and upwards when cooled.

FIG. 2 illustrates an alternative design, in which the molecule orientation differs from one region to another region in the layer 200. Thus, in a first section 201 the liquid crystal molecules have a first orientation that is parallel in the bottom and perpendicular in the top. However, in a second section 202 the molecule orientation is up side down, so that the parallel orientation is at the top end the perpendicular orientation is at the bottom. When heating (or, alternatively, cooling) such a layer, it will bend into a S-shape as illustrated by the arrows.

Alternatively it is possible to use twisted nematic molecule orientations. In such case the molecules preferably have a twist of 90°. Such an orientation will result in similar response to temperature variations. Both the splayed and the twisted configurations will provide the difference in linear thermal expansion. In the twisted configuration the there will be difference in linear expansion in two directions both at the top and at the bottom of the film because at both side we have the anisotropy of the liquid crystal orientation. This results in opposite bending at the top and bottom as illustrated in FIG. 3. However, a twisted orientation results in a geometrically forbidden situation and the resulting bending might therefore be somewhat irregular. Only in the case of high aspect ratio samples, i.e. the length (i) being much larger than the width (w) (typically when l/w>5) the sample will bend in a controlled way.

The splayed orientation is therefore preferred for many applications. The difference in thermal expansion then exhibits itself in one direction only, and the top and bottom surfaces of the layer have equal thermal expansion in the opposite direction. This results in a bending situation that is illustrated in FIG. 4.

In other words, for a twisted configuration:

αₓ^{top} [symbol] αₓ^{bottom} α_{y}^{top}<α_{y}^{bottom} αₓ^{top}=α_{y}^{bottom} α_{y}^{top}=αₓ^{bottom}

whereas for a splayed configuration:

αₓ^{top} [symbol] αₓ^{bottom} α_{y}^{top}=α_{y}^{bottom} αₓ^{top}=α_{y}^{top}

These sets of equations thus makes that the splayed configuration bends in a more controlled way.

A mechanical shutter having a matrix array of shutter elements can be manufactured using the following manufacturing steps, which are illustrated in FIG. 5:

### Step 1

A glass substrate 501 is provided with a striped pattern 502 of indium tin oxide (ITO). To this end an ITO coated glass plate is covered with photoresist and illuminated through a mask. Thereafter the ITO is etched and the resist is stripped. This step can of course be omitted in case no electrodes are needed for the particular application at hand.

### Step 2

The ITO pattern is coated in a patterned way with a structure of a removable orientation layer 503. Conveniently polyvinylalcohol is offset printed and subsequently rubbed in the direction parallel to the ITO stripes 502.

However, polyvinylcinnamate can be used as an alternative for the orientation layer. This material can be applied and locally cross-linked using polarized UV light through a negative mask. In this way patterns with different local orientation can be provided. The non-illuminated areas can be washed away by solvent. The exposed areas can orient the liquid crystal molecules in the direction perpendicular to the E-vector of the polarized light.

### Step 3

The composite resulting from step 2 is covered with a layer 504 of a polymerizable liquid crystal, for example by spin coating. At the location of the orientation layer the polymerizable liquid crystal aligns parallel with the orientation layer interface, that is planar orientation is obtained. At the monomer—air interface the polymerizable liquid crystal instead orients perpendicular to the interface, as schematically shown in FIG. 1, that is a homeotropic orientation is formed. Spin coating can be performed from a 40 percent by weight solution of the monomers using xylene as a solvent. A spinning step of 700 rpm yields a 3.2 μm thick film after evaporation of the solvent. Suitable polymerizable liquid crystals comprise, for example, the following components:

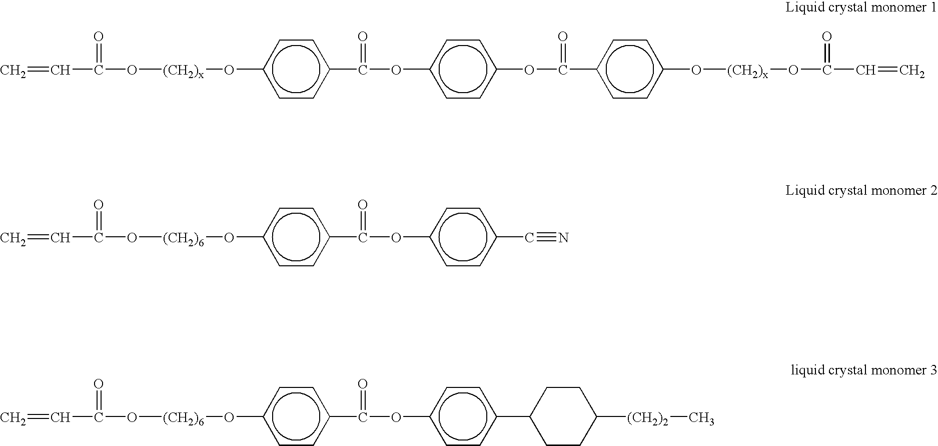

The ratio LC monomer 1:LC monomer 2:LC monomer 3 is preferably 6:2:2 (weight/weight/weight). In order to enhance the sensitivity to ultraviolet light with respect to polymerization, a photoinitiator is added in an amount of 2 wt-%. A convenient photoinitiator is Irgacure 651 that is commercialized by Ciba Geigy. This polymerizable liquid crystal can be molten on the rubbed polyimide orientation layer of the substrate. Alternatively the polymerizable liquid crystal can be coated from solution on the substrate. To that end the mixture can be dissolved in for example xylene. For spin coating of this solution the concentration of monomers preferably is around 40 wt-%. After evaporation of the xylene the typical thickness of the film is around 4 μm. The polymerizable liquid crystal aligns adjacent the orientation layer in a planar fashion with the orientation of the long axes of the molecules on the average parallel to the rubbing direction of the orientation layer. The orientation of the long axes at the opposite side of the liquid crystal layer (the surface that typically interface air) is on the average perpendicular to that surface. Over the cross-section of the film the average orientation of the molecules changes continuously from planar to perpendicular (i.e. the molecules have a splayed orientation).

Surfactants that either promote a homeotropic orientation (i.e. the average direction of the molecules orientated perpendicular to the surface) or that promote planar orientation (i.e. the average direction of the molecules orientated parallel to the surface) can be added to the polymerizable liquid crystal in order to promote the desired molecule orientation. The surfactants are preferably reactive and thus co-polymerize with the liquid-crystalline monomers. It is also advantageous if the surfactants themselves are liquid crystalline, such that they contribute to the overall liquid crystalline structure. An example of a reactive and liquid crystalline surfactant that is known to promote the homeotropic orientation is liquid crystal monomers containing cyano groups at one end and an alkylene group, modified with a polymerizable group such as an acrylate, at the other end. One example of such a surfactant is actually “liquid crystal monomer 2” specified above. Another example is:

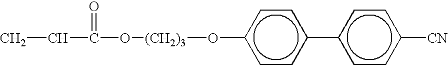

### Step 4

The polymerizable liquid crystal is annealed some time at an elevated temperature in the twisted or splayed state in order to remove order imperfections. The oriented polymerizable liquid crystal is subsequently photo-polymerized at an elevated temperature, e.g. 100° C., by UV exposure (e.g. 365 nm) through a negative mask. This mask blocks the UV light at the area in between the electrode lines and, perpendicular to that, the area where the switching foil elements 505 need to be separated from each other. After polymerization, polymerizable liquid crystal which has not reacted is removed by dissolving in THF (Tetrahydrofuran)

The orientation can be checked by measuring the optical retardation of the polymerized layer and comparing it with the known values of the refractive indices of the molecules in a planar fashion.

### Step 5

In a subsequent step, the polyvinylalcohol orientation layer is removed by dissolving in water. This process is assisted by the addition of a small amount (10 percent by volume) of alcohol to water. When the polyvinlyalcohol dissolves, the elements 505 formed by the freestanding film tend to curl (roll-up) which helps avoiding sticking the underlying substrate which may otherwise occur due to capillary forces. This is an enormous advantage as capillary sticking often occurs and is a phenomenon that is difficult to repair.

The curling of the flaps also contributes to a fast removal of the polyvinylalcohol layer (which serves as a sacrificial layer). This is because as soon as curling occurs a relative large solvent (water) volume is present in contact with the polymer compared to if removal should take place through a very narrow capillary.

However, if further processing of the elements is necessary, the curve shape is often not suited. For instance, applying an additional layer preferably takes place in the flat state. In order to achieve this the elements need to be heated to an elevated temperature again, typically the temperature at which they were originally polymerized or at least close to that temperature.

### Step 6

In case a shutter electrode is desired, a subsequent step might involve the evaporation of a thin metal film 506, e.g. aluminum, on the elements 505. The sample is therefore heated to the polymerization temperature (e.g. 100° C.), whereby the freestanding elements 505 (the flaps) straighten. By evaporation with the source at sufficient distance (parallel evaporation beam) not only the flaps are covered with metal mirror but also the underlying substrate at the locations where the flaps leave an opening to the substrate. The advantage of this is that later, when the elements are in the closed state, the non-touching openings between the flaps will not be open for light transmission but light will be blocked by the metal stripes on the substrates thus improving contrast of the light shutter.

Electrostatic forces can be utilized to switch the various elements. Thereto the ITO lines and the aluminum lines on top of the flaps can form row and column electrodes, respectively, connected to an electrical circuit. FIG. 6 illustrates a mechanical shutter having only one light path 601, covered with two shutter element portions 602, 603 which are suspended on a substrate. The shutter element portions each have an aluminum electrode 604, 605 which are electrically interconnected and thus form a single electrode element, and the substrate are covered with a transparent electrode 606. In case the shutter element is such that it is curled when at room temperature, the light path will be opened. However, in case a voltage (e.g. 60 V) is applied across the electrodes, the shutter element will straighten and thus close the light path.

A typical electro-optical response curve of a single element when light is transmitted from the back is shown in FIG. 7. The material responds to the absolute value of the voltage difference between column and row potentials. As can be seen in FIG. 7, there is a certain threshold voltage below which the shutter is essentially transparent (approximately 68% transmission), and the light output of the backlight is high. The threshold voltage depends on the electrostatic properties of the film material and hence of the polymerized liquid crystal. For instance, the amount of cross-linker is here of eminent importance. In this particular case, the threshold voltage is approximately 30 V.

The threshold voltage can be used for selecting rows, as is also done in conventional passive matrix addressing. FIG. 8 illustrates a possible passive addressing program. According to this program, a row selection voltage of 60 V is used while the column signal range from −30 V to +30 V (−30 V being the on state and +30 V being the off state). If a row is not selected the pixel bias is 30 V maximum (which is below the threshold voltage), while a selected row can vary from 30 V to 90 V.

The shutter element can also be used to make underlying information visible in the open state and hidden in the closed state, respectively. In effect, the micro-mechanical shutter can thereby operate as a display element. In the most simple configuration the surface of the shutter element comprises reflecting layer, such as a thin layer of aluminum, providing a highly reflective surface in the closed state of the shutter, and the light path is provided with a color filter providing for a colored state when the shutter is opened. The aluminum layer can of course operate both as a reflective surface and as a shutter electrode. The aluminum layer might furthermore be diffuse reflecting rather than specular reflecting, giving the surface a paper-like appearance when the shutter element is closed. FIG. 9 illustrates a possible configuration for a display element 900 comprising three sub-pixels; a red (R), a green (G), and a blue (B) sub-pixel arranged on a substrate 901. Each sub-pixel thus comprises a transparent electrode 902, a color filter 903, a shutter element 904 (a layer of polymerized liquid crystal), and a reflective electrode 905. When filters of different colors (such as red, green, and blue) are used for different shutter elements (sub-pixels) in the same display, a colored picture can be build up by opening and closing the switching elements (sub-pixels) in a pixilated way.

According to another configuration the shutter element is covered by a reflective layer that in turn is covered with a color filter.

Still one alternative way to provide a color display is to apply the color filters on the substrate and to make the switching elements light absorbing (i.e. black). When such a display is used in transmissive displays, yellow, magenta and cyan color filters might be provided in the light paths thus providing for differently colored sub-pixels. However, when such a display is used in a reflective display, red, green and blue color filters might used. The color filters might be arranged on a diffusive reflective mirror in order to provide a bright image and a good viewing angle.

In other words, the present invention relates to a mechanical, in particular micro-mechanical shutter 601 that comprises an element 602, 603 formed of a polymerized liquid crystal. The polymerized liquid crystal is anisotropically oriented and has transverse to the layer a variation in orientation and/or concentration making the layer capable of moving in response to non-mechanical means such as heat or electromagnetic radiation. By suitable choice of orientation, for example a splayed or a twisted nematic orientation, the micro-element bends and straightens in response to the non-mechanical means. Electrodes 604, 605, 606 can optionally be formed on the element and on a supporting substrate, making the element controllable by an electric field applied between the electrodes due to resulting electrostatic forces. The invention furthermore provides a method of manufacturing such mechanical shutters using in-situ polymerization.

1. A mechanical shutter having a light path controllable by a shutter element, wherein
said shutter element comprises a layer of oriented polymerized liquid crystal, the polymerized liquid crystal being oriented anisotropically near at least one major surface of the layer, and exhibiting, when moving from the at least one major surface towards the major surface opposite the at least one major surface, a variation in orientation and/or concentration;
the variation being such that the thermal expansion coefficient along a lateral extension of the shutter element is a function of a depth in said shutter element perpendicular to said lateral extension;
such that, at a first temperature, said shutter element is essentially flat and thus closes said light path, and, at a second temperature, said shutter element is bent and thus opens said light path.

2. A mechanical shutter according to claim 1, wherein said shutter element comprises a layer of polymerized liquid crystal wherein the variation is continuous such that the thermal expansion coefficient along a lateral extension of the shutter element is a continuous function of a depth in said shutter element perpendicular to said lateral extension.

3. A mechanical shutter according to claim 1, wherein said polymerized liquid crystal has a splayed orientation.

4. A mechanical shutter according to claim 1, wherein said polymerized liquid crystal has a twisted nematic orientation.

5. A mechanical shutter according to claim 1, wherein said polymerized liquid crystal comprises a light absorbing dichroic dye.

6. A mechanical shutter according to claim 1, wherein said shutter element further comprises a light blocking layer that is arranged on the layer of polymerized liquid crystal.

7. A mechanical shutter according to claim 1, further comprising a base substrate to which said shutter element is suspended, a transparent base electrode provided on the base substrate across said light path, and a shutter electrode provided on said shutter element, such that the shutter element is controllable by means of an electrostatic force set up between said electrodes.

8. A mechanical shutter according to claim 6, wherein said light blocking layer and said shutter electrode is formed out of a single, light blocking and electrically conductive material.

9. A mechanical shutter according to claim 7, comprising an array of shutter elements individually controllable by means of separate electrodes.

10. A mechanical shutter according to claim 1, wherein the layer of polymerized liquid crystal comprises a first and a second, spatially separate section wherein the variation is mutually different.

11. A display element comprising a mechanical shutter according to claim 7.

12. A display element according to claim 11, wherein the shutter element is opaque and wherein a color filter element is provided in said light path.

13. A display element according to claim 11, wherein the shutter element is reflective for light of a certain color and wherein an essentially black light absorbing surface is provided in the light path.

14. Method of manufacturing a mechanical shutter comprising the steps of:
applying an orientation layer on a substrate;
applying a layer of a polymerizable liquid crystal on said orientation layer;
orienting and polymerizing said polymerizable liquid crystal thus defining at least one shutter element comprising a layer of oriented polymerized liquid crystal;
removing any excess polymerizable liquid crystal.

15. Method of manufacturing a mechanical shutter according to claim 14, further comprising the steps of
providing a transparent electrode layer on a transparent base substrate; and
applying a layer of electrically conducting material on said shutter element, thus defining a shutter electrode.

16. Method according to claim 15, wherein the step of applying a layer of electrically conducting material on said shutter element involves sputtering of aluminum on said shutter element.

17. Method according to claim 14, wherein the step of polymerizing involves photo-polymerization.

18. Method according to claim 17, wherein the step of photo-polymerizing is preceded by the step of annealing said liquid crystal mixture at a temperature above 120° C. for at least 30 minutes.

19. Method according to claim 14, wherein said polymerizable liquid crystal comprises a surfactant that promotes a homeotropic orientation of polymerizable liquid crystal monomers when interfacing air, and wherein the step of polymerizing is performed while exposing the polymerizable liquid crystal layer to air.

20. Method according to claim 14, further comprising the step of providing a second, temporary substrate in contact with said polymerizable liquid crystal that induces a desired orientation in said polymerizable liquid crystal, and wherein said step of polymerizing said polymerizable liquid crystal is performed while said second, temporary substrate is in contact with said polymerizable liquid crystal.
